(19) United States
(12) Patent Application Publication
(10) Pub. No.: US 2024/0273394 A1
(43) Pub. Date: Aug. 15, 2024

(54) METHOD OF DETERMINING FUSION PARAMETER, METHOD OF RECOMMENDING INFORMATION, AND METHOD OF TRAINING MODEL

(71) Applicant: BEIJING BAIDU NETCOM SCIENCE TECHNOLOGY CO., LTD., Beijing (CN)

(72) Inventors: Zhaoxu WANG, Beijing (CN); Xiaoyu HU, Beijing (CN); Huijie LIU, Beijing (CN); Yuhang ZHENG, Beijing (CN); Zhiming PENG, Beijing (CN)

(73) Assignee: BEIJING BAIDU NETCOM SCIENCE TECHNOLOGY CO., LTD., Beijing (CN)

(21) Appl. No.: 18/020,606

(22) PCT Filed: Jun. 21, 2022
(86) PCT No.: PCT/CN2022/100122

§ 371 Date: Feb. 9, 2023

(30) Foreign Application Priority Data
Dec. 17, 2021 (CN) 202111565468.1

(51) Int. Cl. G06N 20/00

(52) U.S. Cl. CPC G06N 20/00

(57) ABSTRACT

A method of determining a fusion parameter, a method of recommending an information, a method of training a parameter determination model, an electronic device and a storage medium are provided. The method of determining the fusion parameter includes: inputting a recommendation reference information of a target object into a feature extraction network in a parameter determination model to extract a first object feature for the target object; and inputting the first object feature into a multi-task network in the parameter determination model to obtain a first fusion parameter of a plurality of evaluation indexes for the target object. The plurality of evaluation indexes are used to evaluate a preference of the target object for a recommendation information.

This application claims priority to Chinese Patent Application No. 202111565468.1 filed on Dec. 17, 2021, which is incorporated herein by reference in its entirety.

### TECHNICAL FIELD

The present disclosure relates to a field of an artificial intelligence technology, in particular to a field of an intelligent recommendation technology and a field of a deep learning technology. More specifically, the present disclosure relates to a method and an apparatus of determining a fusion parameter, a method and an apparatus of recommending an information, a method and an apparatus of training a parameter determination model, an electronic device, and a storage medium.

### BACKGROUND

A rapid development has been achieved in recommendation systems with an in-depth development of mobile Internet. With the help of a machine learning technology, a recommendation system may perceive interests and preferences of an object through mining object behaviors, and automatically generate a personalized content recommendation for the object.

### SUMMARY

Based on this, the present disclosure provides a method and an apparatus of determining a fusion parameter, a method and an apparatus of recommending an information, a method and an apparatus of training a parameter determination model, an electronic device and a storage medium for learning large-scale sparse features.

According to an aspect of the present disclosure, a method of determining a fusion parameter is provided, including: inputting a recommendation reference information of a target object into a feature extraction network in a parameter determination model to extract a first object feature for the target object; and inputting the first object feature into a multi-task network in the parameter determination model to obtain a first fusion parameter of a plurality of evaluation indexes for the target object, wherein the plurality of evaluation indexes are configured to evaluate a preference of the target object for a recommendation information.

According to another aspect of the present disclosure, a method of recommending an information is provided, including: determining, for each first information in a plurality of first information to be recommended for the target object, a first evaluation value of the first information for the target object according to an estimation value of a plurality of evaluation indexes of the first information and a first fusion parameter of the plurality of evaluation indexes for the target object; and determining, according to the first evaluation value, a first target information for the target object among the plurality of first information to be recommended and a first information list formed by the first target information, wherein the first fusion parameter is determined by using the method of determining the fusion parameter provided by the present disclosure.

According to another aspect of the present disclosure, a method of training a parameter determination model is provided, wherein the parameter determination model includes a feature extraction network and a multi-task network; the method includes: inputting a recommendation reference information of a reference object into the feature extraction network to extract a second object feature for the reference object; inputting the second object feature into the multi-task network to obtain a second fusion parameter of a plurality of evaluation indexes for the reference object; determining, for each second information in the plurality of second information to be recommended for the reference object, a second evaluation value of the second information for the reference object according to an estimation value of the plurality of evaluation indexes of the second information and the second fusion parameter; determining, according to the second evaluation value, a second target information for the reference object among the plurality of second information to be recommended and a second information list formed by the second target information; and training the multi-task network according to a feedback information of the reference object for the second information list.

According to another aspect of the present disclosure, an apparatus of determining a fusion parameter is provided, including: a first feature extraction module configured to input a recommendation reference information of a target object into a feature extraction network in a parameter determination model to extract a first object feature for the target object; and a first parameter obtaining module configured to input the first object feature into a multi-task network in the parameter determination model to obtain a first fusion parameter of a plurality of evaluation indexes for the target object, wherein the plurality of evaluation indexes are configured to evaluate a preference of the target object for a recommendation information.

According to another aspect of the present disclosure, an apparatus of recommending an information is provided, including: a first evaluation module configured to determine, for each first information in a plurality of first information to be recommended for the target object, a first evaluation value of the first information for the target object according to an estimation value of a plurality of evaluation indexes of the first information and a first fusion parameter of the plurality of evaluation indexes for the target object; and a first information determination module configured to determine, according to the first evaluation value, a first target information for the target object among the plurality of first information to be recommended and a first information list formed by the first target information, wherein the first fusion parameter is determined by using the apparatus of determining the fusion parameter provided by the present disclosure.

According to another aspect of the present disclosure, an apparatus of training a parameter determination model is provided, the parameter determination model includes a feature extraction network and a multi-task network; the apparatus includes: a second feature extraction module configured to input a recommendation reference information of a reference object into the feature extraction network to extract a second object feature for the reference object; a second parameter obtaining module configured to input the second object feature into the multi-task network to obtain a second fusion parameter of a plurality of evaluation indexes for the reference object; a second evaluation module configured to determine, for each second information in the plurality of second information to be recommended for the reference object, a second evaluation value of the second information for the reference object according to an estimation value of the plurality of evaluation indexes of the second information and the second fusion parameter; a second information determination module configured to determine, according to the second evaluation value, a second target information for the reference object among the plurality of second information to be recommended and a second information list formed by the second target information; and a first training module configured to train the multi-task network according to a feedback information of the reference object for the second information list.

According to another aspect of the present disclosure, an electronic device is provided, including: at least one processor; and a memory communicatively connected to the at least one processor, the memory stores instructions executable by the at least one processor, and the instructions, when executed by the at least one processor, cause the at least one processor to implement at least one selected from the method of determining the fusion parameter, the method of recommending the information and the method of training the parameter determination model provided by the present disclosure.

According to another aspect of the present disclosure, a non-transitory computer-readable storage medium having computer instructions therein is provided, and the computer instructions are configured to cause a computer to implement at least one selected from the method of determining the fusion parameter, the method of recommending the information and the method of training the parameter determination model provided by the present disclosure.

According to another aspect of the present disclosure, a computer program product containing a computer program or instructions is provided, and the computer program or instructions, when executed by a processor, cause the processor to implement at least one selected from the method of determining the fusion parameter, the method of recommending the information and the method of training the parameter determination model provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a schematic diagram of an application scenario of a method and an apparatus of determining a fusion parameter, a method and an apparatus of recommending an information and a method and an apparatus of training a parameter determination model according to embodiments of the present disclosure;

FIG. 2 shows a schematic flowchart of a method of training a parameter determination model according to embodiments of the present disclosure:

FIG. 3 shows a schematic structural diagram of a parameter determination model according to embodiments of the present disclosure;

FIG. 4 shows a schematic structural diagram of a parameter determination model according to other embodiments of the present disclosure:

FIG. 5 shows a schematic flowchart of a method of determining a fusion parameter according to embodiments of the present disclosure;

FIG. 6 shows a schematic flowchart of a method of recommending an information according to embodiments of the present disclosure;

FIG. 7 shows a schematic diagram of determining an evaluation value of each first information for a target object according to embodiments of the present disclosure;

FIG. 8 shows a structural block diagram of an apparatus of training a parameter determination model according to embodiments of the present disclosure;

FIG. 9 shows a structural block diagram of an apparatus of determining a fusion parameter according to embodiments of the present disclosure;

FIG. 10 shows a structural block diagram of an apparatus of recommending an information according to embodiments of the present disclosure; and

FIG. 11 shows a block diagram of an electronic device for implementing any one of the method of determining the fusion parameter, the method of recommending the information and the method of training the parameter determination model according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

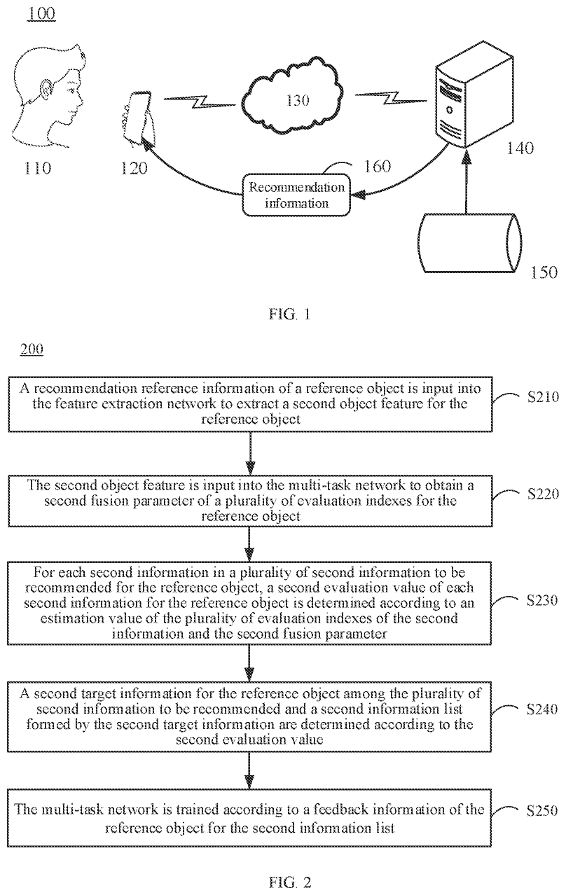

An application scenario of methods and apparatuses provided by the present disclosure will be described below with reference to FIG. 1.

FIG. 1 shows a schematic diagram of an application scenario of a method and an apparatus of determining a fusion parameter, a method and an apparatus of recommending an information and a method and an apparatus of training a parameter determination model according to embodiments of the present disclosure.

As shown in FIG. 1, a scenario 100 in such embodiments contains a user 110 and a terminal device 120, and the terminal device 120 may be used by the user 110 to refresh an information. For example, a refreshed information may include a graphic information, a short video information, a small video information, or a film and television play, etc.

Exemplarily, the terminal device 120 may be a smart phone, a tablet computer, a laptop computer or a desktop computer, etc. The terminal device 120 may be installed with client applications such as web browsers, instant messaging applications, video playing applications, or news information applications (just as examples). The terminal device 120 may interact with a server 140 via a network 130, for example. The network may be a wired or wireless communication link.

In an embodiment, the server 140 may be a background management server for supporting an operation of a client application in the terminal device 120. The terminal device 120 may send an acquisition request to the server 140, for example, in response to a refresh operation or an operation of opening the client application of the user 110. In response to the acquisition request, the server 140 may acquire an information matched with the user 110 from a database 150, and push the acquired information to the terminal device 120 as a recommendation information 160.

In an embodiment, when acquiring the information matched with the user 110 from the database 150, in order to improve a matching degree between the information and the user 110 and increase a probability of the user clicking to browse the information, the server 140 may recall an information from the database 150 by using a resource recall model. The resource recall model may recall an information, for example, according to a similarity between a browsing information of the user and an information in the database. After recalling the information from the database 150, the server 140 may further evaluate the recalled information, for example, according to a plurality of evaluation indexes, and further select and rank the recalled information according to an evaluation result, so as to obtain the recommendation information. Values of the plurality of evaluation indexes may be estimated, for example, according to a user feature and an information feature.

In an embodiment, the server 140 may fuse the values of the plurality of evaluation indexes to obtain an evaluation value of each recalled information with a maximization of the values of the plurality of evaluation indexes as an optimization objective. A fusion parameter when fusing the values of the plurality of evaluation indexes may be obtained using a grid search algorithm, a random search algorithm, a Bayesian optimization algorithm, or a reinforcement learning algorithm, etc.

When performing a multi-objective optimization task using the grid search algorithm, the random search algorithm and the Bayesian optimization algorithm, it generally takes a long time for a process of a parameter optimization, and there may be a problem of a poor optimization effect because different algorithms are good at different scenarios. The reinforcement learning algorithm may achieve a good optimization effect, but an implementation of the reinforcement learning algorithm is generally costly. It is needed to design complex strategy gradients and strategy networks, and needed to consume a lot of computing resources. Furthermore, the implementation of the reinforcement learning algorithm generally relies on dense features, and the reinforcement learning algorithm has a weak learning ability for sparse features, so there is inevitably the problem of poor optimization effect.

In an embodiment, the fusion parameter when fusing the values of the plurality of evaluation indexes may also be determined according to a recommendation reference information of the user by using a parameter determination model described below, and details will not be described here.

It should be noted that the method of determining the fusion parameter, the method of recommending the information and the method of training the parameter determination model provided in embodiments of the present disclosure may all be performed by the server 140. The apparatus of determining the fusion parameter, the apparatus of recommending the information and the apparatus of training the parameter determination model provided in embodiments of the present disclosure may all be provided in the server 140. Alternatively, the method of determining the fusion parameter and the method of training the parameter determination model may be performed by same or different servers communicating with the server 140. Accordingly, the apparatus of determining the fusion parameter and the apparatus of training the parameter determination model may be provided in the same or different servers communicating with the server 140.

It should be understood that the number and type of terminal device, network, server and database in FIG. 1 are merely schematic. According to implementation needs, any number and type of terminal devices, networks, servers and databases may be provided.

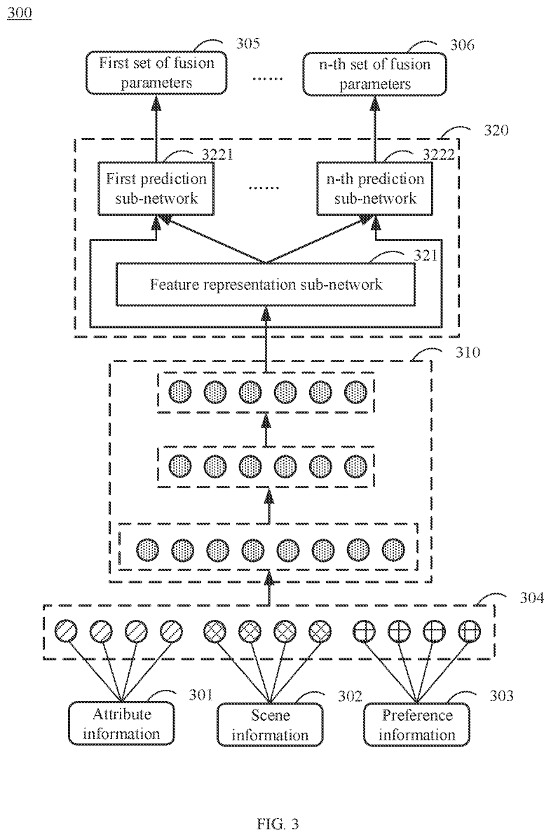

The method of training the parameter determination model provided by the present disclosure will be described in detail below with reference to FIG. 2 to FIG. 4 in conjunction with FIG. 1.

FIG. 2 shows a schematic flowchart of a method of training a parameter determination model according to embodiments of the present disclosure.

As shown in FIG. 2, a method 200 of training a parameter determination model in such embodiments may include operation S210 to operation S250. The parameter determination model may include a feature extraction network and a multi-task network.

In operation S210, a recommendation reference information of a reference object is input into the feature extraction network to extract a second object feature for the reference object.

According to embodiments of the present disclosure, the reference object may be, for example, the above-mentioned user or any object that may use the terminal device. The feature extraction network may include, for example, a network formed by a plurality of nonlinear networks connected in cascade, such as a deep neural network. The feature extraction network may adopt a network that has been trained to extract an object feature in other tasks except a recommendation task.

The recommendation reference information of the reference object may include an attribute information, a portrait information or a behavior information of the reference object. The attribute information may include, for example, a category and a basic information of the reference object. The attribute information may indicate a basic attribute of the reference object, for example, at least one selected from a gender, an age, an education level, an activity degree, or a history like ratio of the object. It may be understood that by introducing the attribute information into the recommendation reference information, it is possible to achieve an object-based personalized recommendation in a subsequent information recommendation, so that a matching degree between an information recommendation result and the object may be improved, and then a user satisfaction may be improved.

In such embodiments, the recommendation reference information may be input into the feature extraction network, and the second object feature may be output by the feature extraction network.

In operation S220, the second object feature is input into the multi-task network to obtain a second fusion parameter of a plurality of evaluation indexes for the reference object.

According to embodiments of the present disclosure, the multi-task network is a machine learning network based on multi-task learning. The multi-task learning is a machine learning method in which a plurality of related tasks (for example, tasks for maximizing values of the plurality of evaluation indexes) are combined based on a shared representation. The multi-task network may include, for example, a Hard parameter sharing model, a Mixture-of-Experts (MOE) model, or a Multi-gate Mixture-of-Experts (MMOE) model.

According to embodiments of the present disclosure, the plurality of evaluation indexes may be used to evaluate a preference of a target object for a recommendation information. For example, the plurality of evaluation indexes may include at least two selected from a click-through rate, a duration for landing page, a duration for list page, comments, likes, and shares.

In operation S230, for each second information in a plurality of second information to be recommended for the reference object, a second evaluation value of each second information for the reference object is determined according to an estimation value of the plurality of evaluation indexes of the second information and the second fusion parameter.

According to embodiments of the present disclosure, the estimation value of the plurality of evaluation indexes may be determined, for example, using relevant prediction models. For example, the click-through rate may be output from a prediction model by inputting the recommendation reference information of the object and each second information into the prediction model. It may be understood that a manner of obtaining the estimation value of the plurality of evaluation indexes is not limited in the present disclosure.

According to embodiments of the present disclosure, the second fusion parameter obtained in operation S220 may include a fusion parameter for each evaluation index. In such embodiments, the fusion parameter for each evaluation index may be used as a weight of the evaluation index, and a weighted sum of the estimation values of the plurality of evaluation indexes may be used as the second evaluation value of each second information for the reference object.

In operation S240, a second target information for the reference object among the plurality of second information to be recommended and a second information list formed by the second target information are determined according to the second evaluation value.

According to embodiments of the present disclosure, a predetermined number of information with a greater second evaluation value among the plurality of second information to be recommended may be determined as the second target information. Then, the predetermined number of second target information may be arranged randomly, or arranged in a descending order of the second evaluation value, so as to obtain the second information list.

According to embodiments of the present disclosure, the second information list may contain, for example, access links to landing pages of the predetermined number of second target information, and the access links may be displayed through titles of the predetermined number of second target information.

In operation S250, the multi-task network is trained according to a feedback information of the reference object for the second information list.

According to embodiments of the present disclosure, the feedback information may be obtained statistically according to an operation of the reference object on the second information list after browsing the second information list. For example, the feedback information may include a click-through rate of the predetermined number of information in the second information list, a duration of browsing the second information list (that is, the above-mentioned duration for list page), a duration of browsing the landing page of a clicked second information in the second information list (that is, the duration for landing page), and so on. In such embodiment, it is also possible to count feedback items of the second information list (i.e., the click-through rate, the duration for list page, the duration for landing page, etc.) from the above-mentioned reference object, and obtained statistical information may be used as the feedback information.

According to embodiments of the present disclosure, the multi-task network may be trained by maximizing the feedback information until the multi-task network reaches a training termination condition. The training termination condition may include that a predetermined number of training times is reached, the feedback information of the reference object for the second information list determined according to the second evaluation value output by the multi-task network tends to be stable, or the like.

In an embodiment, the multi-task network may be trained, for example, using a reinforcement learning algorithm. Specifically, the reinforcement learning algorithm may be used to adjust a network parameter in the multi-task network, so that a strategy of the multi-task network to obtain the second fusion parameter according to the second object feature is adjusted continuously.

In embodiments of the present disclosure, the object feature is extracted from the recommendation reference information by using the feature extraction network before a determination of the second fusion parameter, so that an expressiveness of the object feature input into the multi-task network for sparse recommendation reference information may be improved. That is, by combining the feature extraction network with the multi-task network, the learning of large-scale sparse features may be performed, so that an accuracy of the second fusion parameter determined by the parameter determination model may be increased, and a personalized and scene-oriented multi-objective optimization may be achieved. Accordingly, an accuracy of the recommendation information determined according to the second fusion parameter may be increased to a certain extent, so that the user experience may be improved.

In an embodiment, in addition to the attribute information of the reference object, the recommendation reference information of the reference object may further include a scene information for an information recommendation to the reference object.

The scene information may indicate scene state data during the information recommendation to the reference object. For example, the scene information may include at least one selected from a number of refresh times, a refresh state, a refresh size, a network state, or a refresh period. It may be understood that, by introducing the scene information into the recommendation reference information, different information to be recommended may be recommended to the reference object according to different scenes during subsequent information recommendation, so as to achieve a scene-oriented personalized recommendation.

In an embodiment, in addition to the attribute information of the reference object, the recommendation reference information of the reference object may further include a preference information of the target object for the recommendation information. The preference information may indicate a preference of the reference object for different types of information contents in different types of information. It may be understood that, by introducing the preference information into the recommendation reference information, it is possible to recommend content of interest to the object during subsequent information recommendation, so as to improve the user satisfaction. The preference information may be expressed, for example, in a form of an information pair. The information pair may contain an attribute information of the object and a scene information. Alternatively, the information pair may contain an attribute information of the object and a category of the information to be recommended.

In an embodiment, the recommendation reference information of the reference object may include any one or more selected from the attribute information of the reference object, the preference information of the target object for the recommendation information, or the scene information for the information recommendation to the reference object. For example, the recommendation reference information of the reference object may include the attribute information, the preference information and the scene information. In this way, the feature extraction network may fully learn multi-sided sparse features, and the expressive ability of the obtained object feature may be improved effectively.

In an embodiment, a feedback evaluation value of the reference object for the second information list may be determined according to an interaction information of the reference object for the second information list and an interaction information of the reference object for a selected information in the second information list. The feedback evaluation value may then be used as the feedback information. The interaction information of the reference object for the second information list may include: a duration of the reference object browsing the second information list, a number of information in the second information list clicked by the reference object, and the like. The interaction information of the reference object for the selected information in the second information list may include: a duration of the reference object browsing the landing page of each clicked information, an average duration of the reference object browsing the landing pages of a plurality of clicked information, and the like. By considering both the interaction information of the reference object for the second information list and the interaction information of the reference object for the selected information in the second information list when determining the feedback evaluation value, the expressiveness of the determined feedback information may be improved.

For example, in such embodiments, a sum of the duration for list page and the duration for landing page may be determined as the feedback evaluation value.

For example, the number of information clicked by the reference object, for example, may be further considered when determining the feedback evaluation value. In this way, it is possible to avoid a case that the reference object browses a landing page of a single information for a long time so that the feedback evaluation value is large and may not accurately express a satisfaction degree of the reference object for the second information list. Specifically, in such embodiments, a product of a predetermined average duration per page and the number of clicked information may be added to the above-mentioned sum of the duration for list page and the duration for landing page, so as to obtain the feedback evaluation value. The predetermined average duration per page may be an average duration of the object browsing the landing pages of the recommendation information obtained through statistics, or a value of the predetermined average duration per page may be set as required, which is not limited in the present disclosure.

FIG. 3 shows a schematic structural diagram of a parameter determination model according to embodiments of the present disclosure.

In an embodiment, the above-mentioned information recalled from the database may include a plurality of types of information, that is, the information recommended to the reference object includes a plurality of types of information. Each type of information includes the above-mentioned plurality of evaluation indexes. The value of the fusion parameter may be different for each type of information, so as to improve an accuracy of the evaluation value obtained by evaluating each type of information. This is because a user has different preferences for different types of information.

In an embodiment, when determining the fusion parameter, the parameter determination model not only needs to complete multiple tasks, but also needs to complete a prediction of the fusion parameter for each type of information in a plurality of types of information. For example, the multi-task network in the parameter determination model may include a feature representation sub-network and a plurality of prediction sub-networks. The plurality of prediction sub-networks share a feature output by the feature representation sub-network.

A principle of obtaining a second fusion parameter in such embodiment will be described below with reference to FIG. 3, taking the recommendation reference information including the attribute information, the scene information and the preference information as an example.

As shown in FIG. 3, in an embodiment 300, the parameter determination model includes a feature extraction network 310 and a multi-task network 320. The multi-task network includes a feature representation sub-network 321 and n prediction sub-networks. A first prediction sub-network 3221 to an n^{th} prediction sub-network 3222 in the n prediction sub-networks are respectively used to predict a first set of fusion parameters 305 to an n^{th} set of fusion parameters 306 respectively corresponding to n types. That is, one set of fusion parameters is predicted for each type of information. That set of fusion parameters contains a same number of fusion parameters as the plurality of evaluation indexes.

When obtaining the second fusion parameter, an embedding may be performed on an attribute information 301, a scene information 302 and a preference information 303 of the reference object respectively, so as to obtain three embedded features of the three information. A feature 304 may be obtained by concatenating the three embedded features. In such embodiments, the feature 304 may be input into the feature extraction network 310 to obtain a second object feature. The feature extraction network 310 may be formed by, for example, a plurality of nonlinear networks connected in cascade, and the number of neurons and the number of layers contained in each nonlinear network may be set according to actual needs, which is not limited in the present disclosure.

After the second object feature is obtained, the second object feature may be input into the feature representation sub-network 321, and the feature representation sub-network 321 performs targeted learning on the second object feature, so that the obtained representation feature may better express the preference of the reference object. Alternatively, through the processing of the feature representation sub-network 321, a size of the representation feature may meet a requirement of the n prediction sub-networks for a size of an input feature.

After the representation feature is obtained, the representation feature and the second object feature may be input into each of the n prediction sub-networks. Here, the input to each prediction sub-network includes the second object feature, which may avoid a case that a prediction result is affected due to an incompleteness of the information expressed by the representation feature. Each prediction sub-network may consider the representation feature with different weights, so as to allow the fusion parameters corresponding to different types of information to use the representation feature in different manners, thereby capturing a relationship between different types of information.

For example, the representation feature and the second object feature may be input into the first prediction sub-network 3221, and the first prediction sub-network 3221 may output the first set of fusion parameters 305. The representation feature and the second object feature may be input into the n^{th} prediction sub-network 3222, and the n^{th} prediction sub-network 3222 may output the n^{th} set of fusion parameters 306.

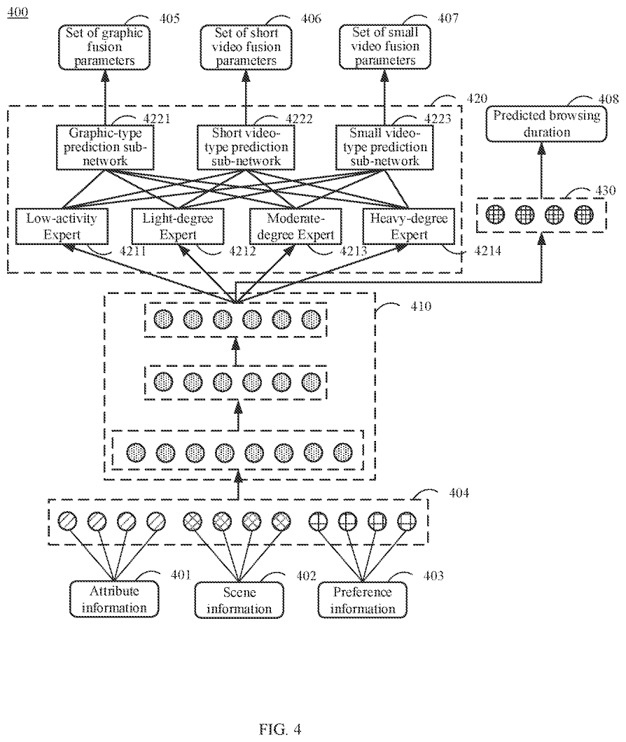

FIG. 4 shows a schematic structural diagram of a parameter determination model according to other embodiments of the present disclosure.

In an embodiment, the feature representation sub-network may include a plurality of expert units, and each expert unit is good at a prediction aspect. For example, the plurality of expert units are respectively used to represent a feature of the reference object for one of a plurality of predetermined object categories according to the second object feature. In this way, the representation features respectively obtained by the plurality of expert units may have expression tendencies. Accordingly, each of the above-mentioned n prediction sub-networks may comprehensively consider outputs of the plurality of expert units according to the second object feature, so that the fusion parameter obtained by each prediction sub-network may more accurately express the preference of the reference object for the type of information corresponding to the prediction sub-network.

For example, a plurality of predetermined object categories may include a global low-activity category, a light-degree category with a light preference for information by information type, a moderate-degree category with a moderate preference for information by information type, and a heavy-degree category with a heavy preference for information by information type. Accordingly, as shown in FIG. 4, the feature representation sub-network may include a low-activity expert unit 4211, a light-degree expert unit 4212, a moderate-degree expert unit 4213, and a heavy-degree expert unit 4214, which are respectively used to represent the features of the reference object belonging to the global activity category, the light-degree category, the moderate-degree category and the heavy-degree category according to the second object feature.

In such embodiments, when obtaining the second fusion parameter, an embedding may be performed on an attribute information 401, a scene information 402 and a preference information 403 respectively, three features obtained by the embedding may be concatenated to obtain a feature 404, and the feature 404 may be input into a feature extraction network 410 to obtain the second object feature. The second object feature is input into the low-activity expert unit 4211, the light-degree expert unit 4212, the moderate-degree expert unit 4213 and the heavy-degree expert unit 4214. Each of the four units outputs a representation feature, and a total of four representation features are obtained.

Taking the plurality of types of information including a graphic-type information, a short video-type information and a small video-type information as an example, after the four representation features are obtained, the four representation features may be input into a graphic-type prediction sub-network 4221 corresponding to a graphic type, a short video-type prediction sub-network 4222 corresponding to a short video type, and a small video-type prediction sub-network 4223 corresponding to a small video type. According to the second object feature, the graphic-type prediction sub-network 4221, the short video-type prediction sub-network 4222 and the small video-type prediction sub-network 4223 respectively determine weights considering the four representation features. The three prediction sub-networks may calculate a weighted sum of the four representation features according to the weights determined respectively. Finally, a second set of fusion parameters is obtained according to the calculated weighted sum. For example, the graphic-type prediction sub-network 4221 may predict a set of graphic fusion parameters 405, the short video-type prediction sub-network 4222 may predict a set of short video fusion parameters 406, and the small video-type prediction sub-network 4223 may predict a set of small video fusion parameters 407.

In an embodiment, the feedback information may further include an actual browsing duration, which may be represented by, for example, a sum of the duration for list and the duration for landing page. In such embodiments, the actual browsing duration may be used as a label of the recommendation reference information of the reference object, so that the feature extraction network may be trained with the actual browsing duration as a supervision, thereby improving a learning ability of the feature extraction network.

For example, as shown in FIG. 4, in an embodiment 400, the parameter determination model may include a prediction network 430 in addition to the feature extraction network 410 and the multi-task network 420. The prediction network 430 may include, for example, a fully connected network, and may be used to predict a duration of the reference object browsing the recommendation information according to the second object feature.

For example, the second object feature output by the feature extraction network 410 may be input into the prediction network 430, and a predicted browsing duration 408 is output by the prediction network 430. In such embodiments, the feature extraction network and the prediction network may be trained according to a difference between the predicted browsing duration and the actual browsing duration. For example, a loss of a network model formed by the feature extraction network and the prediction network may be determined according to the predicted browsing duration and the actual browsing duration. Then, network parameters in the feature extraction network and the prediction network may be adjusted using a back-propagation algorithm to minimize the loss of the network model. For example, the loss of the network model may be determined using an L1 loss function or an L2 loss function, which is not limited in the present disclosure.

In embodiments of the present disclosure, by providing the prediction network and training the feature extraction network according to the predicted browsing duration and the actual browsing duration indicated by the label, it is possible to perform a supervised training of the feature extraction network. In this way, the learning ability of the feature extraction network for sparse features may be further improved, and thus an applicable range of the parameter determination model may be expanded and the accuracy of the parameter determination model may be improved.

It may be understood that, in an embodiment, the MMOE model may be used as an architecture of the multi-task network, so that multi-objective optimization tasks in multiple scenes may be performed. Furthermore, the MMOE model may reduce a parameter scale of the model and prevent simulation over-fitting by allowing the plurality of prediction sub-networks to share the feature representation sub-network. In addition, by introducing a gate structure as an attention mechanism of learning between different scenes, the MMOE may consider a relevance of tasks between multiple scenes, and also limit specificities of different scenes. Therefore, the accuracy of the predicted fusion parameter may be improved.

In an embodiment, for example, the multi-task network may be trained by adding noise to a network parameter in the multi-task network. For example, a noise direction of the network parameter may be determined according to a feedback information brought by adding the noise to the network parameter.

Exemplarily, a noise value added to the network parameter may be generated according to an identification information of the reference object. Then, a plurality of network parameters are adjusted according to the feedback evaluation value and the noise value. The identification information of the reference object may include, for example, an account information of the reference object. The generated noise value may be in a form of an array, and the data contains the noise value for each network parameter. The feedback evaluation value may be, for example, negatively correlated with the noise value. For example, a small noise value may be added to the network parameter if the feedback evaluation value is large.

An encryption operation may be performed on the identification information to obtain a random number seed, and then a set of noise values may be generated based on the random number seed by using a distribution function. The encryption operation may be implemented using a hash algorithm, etc., and the distribution function may be, for example, a Gaussian distribution function, etc. The algorithm used for the encryption operation and the type of the distribution function are not limited in the present disclosure.

In an embodiment, when generating the noise value, for example, a time information may be further considered to ensure a diversity of the generated noise value. For example, the time information may include a date information and/or a clock information. In such embodiments, the random number seed may be obtained by performing an encryption operation on the identification information and the time information.

Exemplarily, when adjusting the plurality of network parameters, for example, an adjustment stride of each network parameter may be firstly determined according to a ratio of the feedback evaluation value to the noise value of the network parameter. Then, the network parameters are adjusted according to the adjustment stride. In an embodiment, the ratio of the feedback evaluation value to the noise value of each network parameter may be directly used as the adjustment stride. Alternatively, a hyper-parameter may be added for the ratio, and a product of the hyper-parameter and the ratio may be used as the adjustment stride. A value of the hyper-parameter may be set according to actual needs, which is not limited in the present disclosure.

Exemplarily, a plurality of recommendation reference information of a batch of reference objects may be used as a batch of training samples. In such embodiments, a ratio of an average value of a plurality of feedback evaluation values obtained according to the batch of training samples to the noise value of each network parameter may be used as a basis for determining the adjustment stride of the network parameter.

In such embodiments, the multi-task model is trained by adding the noise value and considering the feedback result, then it is not needed to design complex strategy gradients, and computing resources may be saved.

In an embodiment, a plurality of sets of noise values may be generated using the above-mentioned methods. Each set of noise values may contain a plurality of noise values respectively corresponding to the plurality of network parameters in the multi-task network. In such embodiments, a target set of noise values for adjusting the plurality of network parameters may be determined using an evolution algorithm, so as to improve a training effect of the multi-task network.

For example, the evolution algorithm may be used to determine the target set of noise values by considering the feedback evaluation value and the plurality of sets of noise values. For example, the evolution algorithm may be used to fuse the plurality of sets of noise values to obtain the target set of noise values, with a maximization of the feedback evaluation value as an objective. The fusion method may be implemented by adding a coefficient for each set of noise values, which is not limited in the present disclosure. After the target set of noise values is obtained, such embodiments may be implemented to determine the adjustment stride of each network parameter according to the feedback evaluation value and the target set of noise values, and adjust the network parameter according to the adjustment stride.

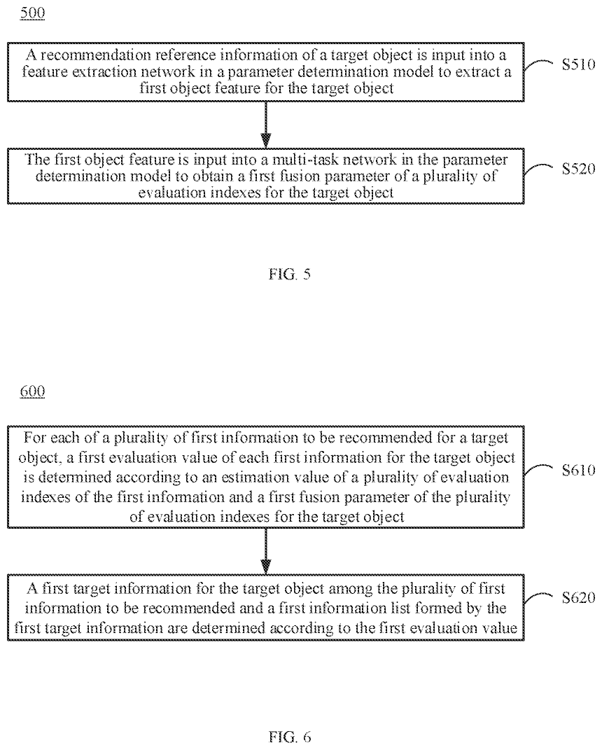

So far, detailed descriptions of the method of training the parameter determination model are completed. Based on a trained parameter determination model in the present disclosure, the present disclosure further provides a method of determining a fusion parameter, which will be described in detail below with reference to FIG. 5.

FIG. 5 shows a schematic flowchart of a method of determining a fusion parameter according to embodiments of the present disclosure.

As shown in FIG. 5, a method 500 of determining a fusion parameter in such embodiments includes operation S510 to operation S520.

In operation S510, a recommendation reference information of a target object is input into a feature extraction network in a parameter determination model to extract a first object feature for the target object.

The target object may be a user refreshing an information, and the target object is similar to the above-mentioned reference object. The recommendation reference information of the target object is similar to the above-mentioned recommendation reference information of the reference object, and may include, for example, at least one selected from: an attribute information of the target object, a scene information for an information recommendation to the target object, or a preference information of the target object for a recommendation information. An implementation of operation S510 is similar to that of operation S210 described above, and details will not be repeated here.

In operation S520, the first object feature is input into a multi-task network in the parameter determination model to obtain a first fusion parameter of a plurality of evaluation indexes for the target object.

The first fusion parameter is similar to the above-mentioned second fusion parameter. The plurality of evaluation indexes are used to evaluate the preference of the target object for the recommendation information. An implementation of operation S520 is similar to that of operation S220 described above, and details will not be repeated here.

In embodiments of the present disclosure, when determining the fusion parameter, the object feature is extracted firstly according to the recommendation reference information, and then the first fusion parameter is determined by the multi-task network, so that a large number of sparse features are taken into account when obtaining the fusion parameter, and thus the accuracy of the fusion parameter may be improved. Furthermore, in the present disclosure, the fusion parameter is obtained using the multi-task network. Different from a technical solution of outputting a recommendation information directly by a multi-task network, the method in such embodiments may be applied to the information recommendation in multiple scenes, and a robustness of the method may be improved.

According to embodiments of the present disclosure, similar to the foregoing descriptions, the information recommended to the target object may include a plurality of types of information, and each type of information has a plurality of evaluation indexes. In such embodiments, the first fusion parameter may be obtained using the above-mentioned multi-task network including a feature representation sub-network and a plurality of prediction sub-networks. Specifically, the first object feature may be input into the feature representation sub-network to obtain a representation feature. Then, the representation feature and the first object feature are input into the plurality of prediction sub-networks, and each of the plurality of prediction sub-networks outputs a set of fusion parameters. The plurality of prediction sub-networks respectively correspond to the plurality of types of information, and each set of fusion parameters contains respective fusion parameters of the plurality of evaluation indexes.

According to embodiments of the present disclosure, similar to the foregoing descriptions, the feature representation sub-network may include a plurality of expert units. In such embodiments, when obtaining the representation feature, the object feature may be input into each of the plurality of expert units, and each expert unit outputs a representation feature. The plurality of expert units are respectively used to represent a feature of the target object for one of a plurality of predetermined object categories according to the first object feature.

Based on the method of determining the fusion parameter provided in the present disclosure, the present disclosure further provides a method of recommending an information, which will be described in detail below with reference to FIG. 6.

FIG. 6 shows a schematic flowchart of a method of recommending an information according to embodiments of the present disclosure.

As shown in FIG. 6, a method 600 of recommending an information in such embodiments includes operation S610 to operation S620.

In operation S610, for each of a plurality of first information to be recommended for a target object, a first evaluation value of each first information for the target object is determined according to an estimation value of a plurality of evaluation indexes of the first information and a first fusion parameter of the plurality of evaluation indexes for the target object.

The first information to be recommended is similar to the above-mentioned second information to be recommended, and a manner of obtaining the first information to be recommended is also similar to that of obtaining the second information to be recommended, which will not be repeated here.

The first fusion parameter may be obtained using the above-mentioned method of determining the fusion parameter. An implementation of operation S610 is similar to that of operation S230 described above, and details will not be repeated here.

In operation S620, a first target information for the target object among the plurality of first information to be recommended and a first information list formed by the first target information are determined according to the first evaluation value.

The method of determining the first target information and the first information list is similar to the method of determining the second target information and the second information list in operation S240 described above, and details will not be repeated here.

FIG. 7 shows a schematic diagram of determining an evaluation value of each first information for a target object according to embodiments of the present disclosure.

In an embodiment, the plurality of first information to be recommended may include, for example, at least two types of information. The at least two types may be any at least two types selected from the above-mentioned plurality of types of the recommendation information. Accordingly, a set of fusion parameters is obtained for each type of information.

As shown in FIG. 7, in an embodiment 700, when determining the first evaluation value of each first information for the target object, an information type of each first information 710 may be determined firstly. Then, a set of fusion parameters corresponding to an information type 720 of the first information is found from a plurality of sets of fusion parameters respectively corresponding to the plurality of types obtained by using a parameter determination model 701, and is used as a set of fusion parameters 730 for the first information 710.

If a number of the plurality of evaluation indexes is set to be m, then the set of fusion parameters 730 obtained in such embodiments may contain a first fusion parameter 731 to an m^{th} fusion parameter 732, which correspond to a first evaluation index 741 to an m^{th} evaluation index 742 among the plurality of evaluation indexes respectively. In an embodiment, a fusion value of each evaluation index may be determined according to the evaluation index and the fusion parameter of the evaluation index for the target object. For example, a product of the first evaluation index 741 and the first fusion parameter 731 may be used as a first fusion value 751. Similarly, a total of m fusion values including the first fusion value 751 to an m^{th} fusion value 752 may be obtained. Finally, a first evaluation value 760 may be determined according to the plurality of fusion values. In this way, the plurality of evaluation indexes may be fused effectively, and the accuracy of the first evaluation value may be improved.

For example, after the set of fusion parameters 730 is obtained, such embodiments may be implemented to calculate a weighted sum of the m evaluation indexes by using the m fusion parameters as weights of the m evaluation indexes respectively, so as to obtain the first evaluation value.

For example, in such embodiments, the fusion parameter may be used as an exponent of the estimation value of the evaluation index to calculate the fusion value. Finally, the m fusion values are multiplied to obtain the evaluation value. In such embodiments, the fusion value is determined in an exponential manner, so that a degree of influence of the fusion parameter on the fusion value may be increased, and the accuracy of the obtained evaluation value may be improved. Furthermore, the evaluation value is obtained by multiplying the fusion values, so that the evaluation values of different information may have a great difference, which may facilitate the determination of the first target information.

By determining the fusion parameter of the plurality of evaluation indexes using the parameter determination model and finally determining the evaluation value of the information according to the fusion parameter, the method of recommending the information in such embodiments may be applied in a wider range compared with a technical solution of outputting a recommendation information directly using a model. In recommendation scenes for different types of information, there is no need to adjust the model, and an efficiency of information recommendation may be improved.

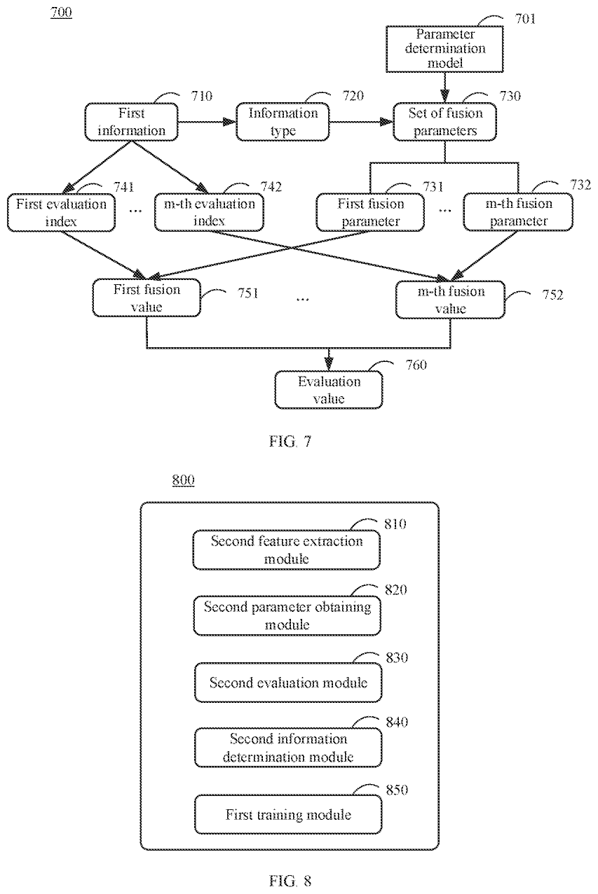

Based on the method of training the parameter determination model provided in the present disclosure, the present disclosure further provides an apparatus of training a parameter determination model, which will be described in detail below with reference to FIG. 8.

FIG. 8 shows a structural block diagram of an apparatus of training a parameter determination model according to embodiments of the present disclosure.

As shown in FIG. 8, an apparatus 800 of training a parameter determination model in such embodiments may include a second feature extraction module 810, a second parameter obtaining module 820, a second evaluation module 830, a second information determination module 840, and a first training module 850. The parameter determination model includes a feature extraction network and a multi-task network.

The second feature extraction module 810 may be used to input a recommendation reference information of a reference object into the feature extraction network to extract a second object feature for the reference object. In an embodiment, the second feature extraction module 810 may be used to perform operation S210 described above, and details will not be repeated here.

The second parameter obtaining module 820 may be used to input the second object feature into the multi-task network to obtain a second fusion parameter of a plurality of evaluation indexes for the reference object. In an embodiment, the second parameter obtaining module 820 may be used to perform operation S220 described above, and details will not be repeated here.

The second evaluation module 830 may be used to determine, for each second information in the plurality of second information to be recommended for the reference object, a second evaluation value of the second information for the reference object according to an estimation value of the plurality of evaluation indexes of the second information and the second fusion parameter. In an embodiment, the second evaluation module 830 may be used to perform operation S230 described above, and details will not be repeated here.

The second information determination module 840 may be used to determine, according to the second evaluation value, a second target information for the reference object among the plurality of second information to be recommended and a second information list formed by the second target information. In an embodiment, the second information determination module 840 may be used to perform operation S240 described above, and details will not be repeated here.

The first training module 850 may be used to train the multi-task network according to a feedback information of the reference object for the second information list. In an embodiment, the first training module 850 may be used to perform operation S250 described above, and details will not be repeated here.

According to embodiments of the present disclosure, the apparatus 800 of training the parameter determination model may further include a feedback information determination module used to determine the feedback information of the reference object for the second information list by: determining a feedback evaluation value of the reference object for the second information list according to an interaction information of the reference object for the second information list and an interaction information of the reference object for a selected information in the second information list. The feedback information includes the feedback evaluation value.

According to embodiments of the present disclosure, the first training module 850 may include a noise value generation sub-module and a parameter adjustment sub-module. The noise value generation sub-module may be used to generate a noise value for a plurality of network parameters in the multi-task network according to an identification information of the reference object. The parameter adjustment sub-module may be used to adjust the plurality of network parameters according to the feedback evaluation value and the noise value for the plurality of network parameters.

According to embodiments of the present disclosure, the noise value for the plurality of network parameters includes a plurality of noise values respectively corresponding to the plurality of network parameters. The parameter adjustment sub-module may include a stride determination unit and a first adjustment unit. The stride determination unit may be used to determine, for each of the plurality of network parameters, an adjustment stride for the network parameter according to a ratio of the feedback evaluation value to the noise value corresponding to the network parameter. The first adjustment unit may be used to adjust each network parameter according to the adjustment stride.

According to embodiments of the present disclosure, the noise value for the plurality of network parameters includes a plurality of sets of noise values, each of the plurality of sets of noise values contains a plurality of noise values respectively corresponding to the plurality of network parameters. The parameter adjustment sub-module may include a target noise determination unit and a second adjustment unit. The target noise determination unit may be used to determine, by using an evolution algorithm, a target set of noise values according to the feedback evaluation value and the plurality of sets of noise values for the plurality of network parameters. The second adjustment unit may be used to adjust the plurality of network parameters according to the feedback evaluation value and the target set of noise values.

According to embodiments of the present disclosure, the feedback information includes an actual browsing duration; the parameter determination model further includes a prediction network. The apparatus 800 of training the parameter determination model may further include a duration prediction module and a second training module. The duration prediction module may be used to input the second object feature into the prediction network to obtain a predicted browsing duration. The second training module may be used to train the feature extraction network and the prediction network according to a difference between the actual browsing duration and the predicted browsing duration.

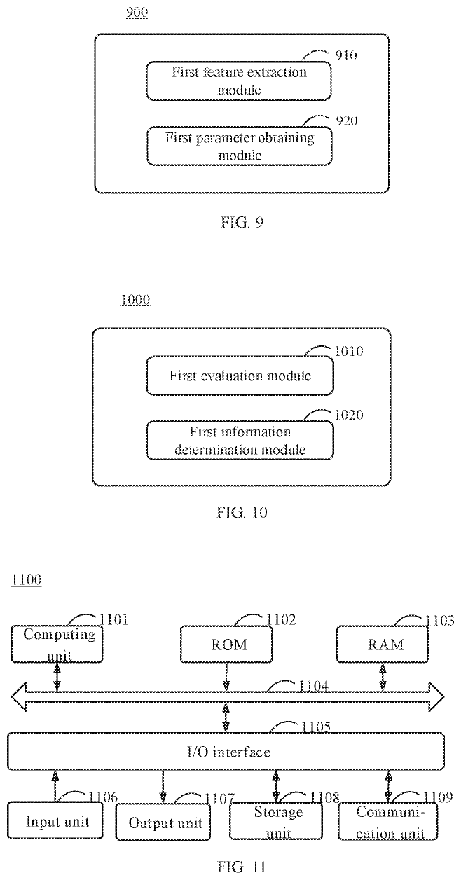

Based on the method of determining the fusion parameter provided by the present disclosure, the present disclosure further provides an apparatus of determining a fusion parameter, which will be described in detail below with reference to FIG. 9.

FIG. 9 shows a structural block diagram of an apparatus of determining a fusion parameter according to embodiments of the present disclosure.

As shown in FIG. 9, an apparatus 900 of determining a fusion parameter according to such embodiments may include a first feature extraction module 910 and a first parameter obtaining module 920.

The first feature extraction module 910 may be used to input a recommendation reference information of a target object into a feature extraction network in a parameter determination model to extract a first object feature for the target object. In an embodiment, the first feature extraction module 910 may be used to perform operation S510 described above, and details will not be repeated here.

The first parameter obtaining module 920 may be used to input the first object feature into a multi-task network in the parameter determination model to obtain a first fusion parameter of a plurality of evaluation indexes for the target object. The plurality of evaluation indexes are used to evaluate a preference of the target object for a recommendation information. In an embodiment, the first parameter obtaining module 920 may be used to perform operation S520 described above, and details will not be repeated here.

According to embodiments of the present disclosure, the recommendation information includes a plurality of types of information; each type of information has the plurality of evaluation indexes. The multi-task network includes a feature representation sub-network and a plurality of prediction sub-networks. The first parameter obtaining module 920 may include a feature obtaining sub-module and a parameter obtaining sub-module. The feature obtaining sub-module may be used to input the first object feature into the feature representation sub-network to obtain a representation feature. The parameter obtaining sub-module may be used to input the representation feature and the first object feature into the plurality of prediction sub-networks, so as to output a set of fusion parameters by each of the plurality of prediction sub-networks. The plurality of prediction sub-networks correspond to the plurality of types respectively, and the set of fusion parameters contains fusion parameters of the plurality of evaluation indexes.

According to embodiments of the present disclosure, the feature representation sub-network includes a plurality of expert units; the feature obtaining sub-module is further used to: input the first object feature into each of the plurality of expert units, so as to output a representation feature by each expert unit. The plurality of expert units are respectively used to represent a feature of the target object for one of a plurality of predetermined object categories according to the first object feature.

According to embodiments of the present disclosure, the recommendation reference information of the target object includes at least one selected from: an attribute information of the target object; a scene information for an information recommendation to the target object; or a preference information of the target object for a recommendation information.

Based on the method of recommending the information provided by the present disclosure, the present disclosure further provides an apparatus of recommending an information, which will be described in detail below with reference to FIG. 10.

FIG. 10 shows a structural block diagram of an apparatus of recommending an information according to embodiments of the present disclosure.

As shown in FIG. 10, an apparatus 1000 of recommending an information according to such embodiments may include a first evaluation module 1010 and a first information determination module 1020.

The first evaluation module 1010 may be used to determine, for each first information in a plurality of first information to be recommended for the target object, a first evaluation value of the first information for the target object according to an estimation value of a plurality of evaluation indexes of the first information and a first fusion parameter of the plurality of evaluation indexes for the target object. The first fusion parameter may be determined by using the apparatus of determining the fusion parameter described above. In an embodiment, the first evaluation module 1010 may be used to perform operation S610 described above, and details will not be repeated here.

The first information determination module 1020 may be used to determine, according to the first evaluation value, a first target information for the target object among the plurality of first information to be recommended and a first information list formed by the first target information. In an embodiment, the first information determination module 1020 may be used to perform operation S620 described above, and details will not be repeated here.

According to embodiments of the present disclosure, the plurality of first information to be recommended include at least two types of information. The first evaluation module 1010 may include a parameter determination sub-module and an evaluation value determination sub-module. The parameter determination sub-module may be used to determine, according to a type of each first information, a plurality of fusion parameters of the plurality of evaluation indexes for the target object, so as to obtain a set of fusion parameters for the first information. The set of fusion parameters correspond to the types of information respectively. The evaluation value determination sub-module may be used to determine the first evaluation value according to the estimation value of the plurality of evaluation indexes of the first information and the set of fusion parameters.

According to embodiments of the present disclosure, the evaluation value determination sub-module may include a fusion value determination unit and an evaluation value determination unit. The fusion value determination unit may be used to determine, for each of the plurality of evaluation indexes, a fusion value of the evaluation index according to the estimation value of the evaluation index and a fusion parameter of the evaluation index for the target object in the set of fusion parameters. The evaluation value determination unit may be used to determine the first evaluation value according to a plurality of fusion values of the plurality of evaluation indexes.

It should be noted that in technical solutions of the present disclosure, an acquisition, a collection, a storage, a use, a processing, a transmission, a provision, a disclosure, an application and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

According to embodiments of the present disclosure, the present disclosure further provides an electronic device, a readable storage medium, and a computer program product.

FIG. 11 shows a block diagram of an electronic device for implementing any one selected from the method of determining the fusion parameter, the method of recommending the information and the method of training the parameter determination model in embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 11, the electronic device 1100 includes a computing unit 1101 which may perform various appropriate actions and processes according to a computer program stored in a read only memory (ROM) 1102 or a computer program loaded from a storage unit 1108 into a random access memory (RAM) 1103. In the RAM 1103, various programs and data necessary for an operation of the electronic device 1100 may also be stored. The computing unit 1101, the ROM 1102 and the RAM 1103 are connected to each other through a bus 1104. An input/output (I/O) interface 1105 is also connected to the bus 1104.

A plurality of components in the electronic device 1100 are connected to the I/O interface 1105, including: an input unit 1106, such as a keyboard, or a mouse; an output unit 1107, such as displays or speakers of various types; a storage unit 1108, such as a disk, or an optical disc; and a communication unit 1109, such as a network card, a modem, or a wireless communication transceiver. The communication unit 1109 allows the electronic device 1100 to exchange information/data with other devices through a computer network such as Internet and/or various telecommunication networks.

The computing unit 1101 may be various general-purpose and/or dedicated processing assemblies having processing and computing capabilities. Some examples of the computing units 1101 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1101 executes various methods and processes described above, such as any one selected from the method of determining the fusion parameter, the method of recommending the information and the method of training the parameter determination model. For example, in some embodiments, any one selected from the method of determining the fusion parameter, the method of recommending the information and the method of training the parameter determination model may be implemented as a computer software program which is tangibly embodied in a machine-readable medium, such as the storage unit 1108. In some embodiments, the computer program may be partially or entirely loaded and/or installed in the electronic device 1100 via the ROM 1102 and/or the communication unit 1109. The computer program, when loaded in the RAM 1103 and executed by the computing unit 1101, may execute one or more steps in any one selected from the method of determining the fusion parameter, the method of recommending the information and the method of training the parameter determination model described above. Alternatively, in other embodiments, the computing unit 1101 may be used to perform any one selected from the method of determining the fusion parameter, the method of recommending the information and the method of training the parameter determination model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak service scalability existing in an existing physical host and VPS (Virtual Private Server) service. The server may also be a server of a distributed system or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of determining a fusion parameter, the method comprising:
inputting a recommendation reference information of a target object into a feature extraction network in a parameter determination model to extract a first object feature for the target object; and
inputting the first object feature into a multi-task network in the parameter determination model to obtain a first fusion parameter of a plurality of evaluation indexes for the target object,
wherein the plurality of evaluation indexes are configured to evaluate a preference of the target object for a recommendation information.

2. The method according to claim 1, wherein the recommendation information comprises a plurality of types of information each type of information has the plurality of evaluation indexes, and the multi-task network comprises a feature representation sub-network and a plurality of prediction sub-networks; and
wherein the inputting the first object feature into a multi-task network in the parameter determination model to obtain a first fusion parameter of a plurality of evaluation indexes for the target object comprises:
inputting the first object feature into the feature representation sub-network to obtain a representation feature; and
inputting the representation feature and the first object feature into the plurality of prediction sub-networks, so as to output a set of fusion parameters by each of the plurality of prediction sub-networks,
wherein the plurality of prediction sub-networks correspond to the plurality of types respectively, and the set of fusion parameters contains fusion parameters of the plurality of evaluation indexes.

3. The method according to claim 2, wherein the feature representation sub-network comprises a plurality of expert units; and
wherein the inputting the first object feature into the feature representation sub-network to obtain a representation feature comprises inputting the first object feature into each of the plurality of expert units, so as to output a representation feature by each expert unit,
wherein the plurality of expert units are respectively configured to represent a feature of the target object for one of a plurality of predetermined object categories according to the first object feature.

4. The method according to claim 1, wherein the recommendation reference information of the target object comprises at least one selected from:
an attribute information of the target object;
a scene information for an information recommendation to the target object; or
a preference information of the target object for a recommendation information.

5. A method of recommending an information, the method comprising:
determining, for each first information in a plurality of first information to be recommended for the target object, a first evaluation value of the first information for the target object according to an estimation value of a plurality of evaluation indexes of the first information and a first fusion parameter of the plurality of evaluation indexes for the target object; and
determining, according to the first evaluation value, a first target information for the target object among the plurality of first information to be recommended and a first information list formed by the first target information,
wherein the first fusion parameter is determined by using the method of claim 1.

6. The method according to claim 5, wherein the plurality of first information to be recommended comprise at least two types of information; and
wherein the determining a first evaluation value of the first information for the target object according to an estimation value of a plurality of evaluation indexes of the first information and a first fusion parameter of the plurality of evaluation indexes for the target object comprises:
determining, according to a type of each first information, a plurality of fusion parameters of the plurality of evaluation indexes for the target object, so as to obtain a set of fusion parameters for each first information, wherein the set of fusion parameters correspond to the type of the information; and
determining the first evaluation value according to the estimation value of the plurality of evaluation indexes of the first information and the set of fusion parameters.

7. The method according to claim 6, wherein the determining the first evaluation value according to the estimation value of the plurality of evaluation indexes of the first information and the set of fusion parameters comprises:
determining, for each of the plurality of evaluation indexes, a fusion value of the evaluation index according to the estimation value of the evaluation index and a fusion parameter of the evaluation index for the target object in the set of fusion parameters; and
determining the first evaluation value according to a plurality of fusion values of the plurality of evaluation indexes.

8. A method of training a parameter determination model, wherein the parameter determination model comprises a feature extraction network and a multi-task network; the method comprises:
inputting a recommendation reference information of a reference object into the feature extraction network to extract a second object feature for the reference object;
inputting the second object feature into the multi-task network to obtain a second fusion parameter of a plurality of evaluation indexes for the reference object;
determining, for each second information in a plurality of second information to be recommended for the reference object, a second evaluation value of the second information for the reference object according to an estimation value of the plurality of evaluation indexes of the second information and the second fusion parameter;
determining, according to the second evaluation value, a second target information for the reference object among the plurality of second information to be recommended and a second information list formed by the second target information; and
training the multi-task network according to a feedback information of the reference object for the second information list.

9. The method according to claim 8, further comprising determining the feedback information of the reference object for the second information list by determining a feedback evaluation value of the reference object for the second information list according to an interaction information of the reference object for the second information list and an interaction information of the reference object for a selected information in the second information list, wherein the feedback information comprises the feedback evaluation value.

10. The method according to claim 9, wherein the training the multi-task network according to a feedback information of the reference object for the second information list comprises:
generating a noise value for a plurality of network parameters in the multi-task network according to an identification information of the reference object; and
adjusting the plurality of network parameters according to the feedback evaluation value and the noise value for the plurality of network parameters.

11. The method according to claim 10, wherein a plurality of noise values respectively correspond to the plurality of network parameters; and
wherein the adjusting the plurality of network parameters according to the feedback evaluation value and the noise value for the plurality of network parameters comprises:
determining, for each of the plurality of network parameters, an adjustment stride for the network parameter according to a ratio of the feedback evaluation value to the noise value corresponding to the network parameter; and
adjusting each network parameter according to the adjustment stride.

12. The method according to claim 10, wherein a plurality of sets of noise values are generated for the plurality of network parameters, each of the plurality of sets of noise values contains a plurality of noise values respectively corresponding to the plurality of network parameters; and
wherein the adjusting the plurality of network parameters according to the feedback evaluation value and the noise value for the plurality of network parameters comprises:
determining, by using an evolution algorithm, a target set of noise values according to the feedback evaluation value and the plurality of sets of noise values for the plurality of network parameters; and
adjusting the plurality of network parameters according to the feedback evaluation value and the target set of noise values.

13. The method according to claim 9, wherein the feedback information comprises an actual browsing duration, and the parameter determination model further comprises a prediction network; and
the method further comprises:
inputting the second object feature into the prediction network to obtain a predicted browsing duration; and
training the feature extraction network and the prediction network according to a difference between the actual browsing duration and the predicted browsing duration.

14.-26. (canceled)

27. An electronic device, comprising:
at least one processor; and
a memory communicatively connected to the at least one processor, wherein the memory stores instructions executable by the at least one processor, and the instructions, when executed by the at least one processor, cause the at least one processor to implement at least the method of claim 1.

28. A non-transitory computer-readable storage medium having computer instructions therein, wherein the computer instructions are configured to cause a computer system to implement at least the method of claim 1.

29. (canceled)

30. The electronic device according to claim 27, wherein the recommendation information comprises a plurality of types of information; each type of information has the plurality of evaluation indexes; the multi-task network comprises a feature representation sub-network and a plurality of prediction sub-networks; and
wherein the instructions are further configured to cause the at least one processor to:
input the first object feature into the feature representation sub-network to obtain a representation feature; and
input the representation feature and the first object feature into the plurality of prediction sub-networks, so as to output a set of fusion parameters by each of the plurality of prediction sub-networks,
wherein the plurality of prediction sub-networks correspond to the plurality of types respectively, and the set of fusion parameters contains fusion parameters of the plurality of evaluation indexes.

31. An electronic device, comprising:
at least one processor; and
a memory communicatively connected to the at least one processor, wherein the memory stores instructions executable by the at least one processor, and the instructions, when executed by the at least one processor, cause the at least one processor to implement at least the method of claim 5.

32. A non-transitory computer-readable storage medium having computer instructions therein, wherein the computer instructions are configured to cause a computer system to implement at least the method of claim 5.

33. An electronic device, comprising:
at least one processor; and
a memory communicatively connected to the at least one processor, wherein the memory stores instructions executable by the at least one processor, and the instructions, when executed by the at least one processor, cause the at least one processor to implement at least the method of claim 8.

34. A non-transitory computer-readable storage medium having computer instructions therein, wherein the computer instructions are configured to cause a computer system to implement at least the method of claim 8.
